(19) United States
(12) Patent Application Publication
(10) Pub. No.: US 2003/0138528 A1
(43) Pub. Date: Jul. 24, 2003

(54) Animal treat

(76) Inventor: Frank Jay Hague, Plano, TX (US)

Correspondence Address: DECKER, JONES, MCMACKIN, MCCLANE, HALL &, BATES, P.C., BURNETT PLAZA 2000, 801 CHERRY STREET, UNIT #46, FORT WORTH, TX, 76102-6836, US

(21) Appl. No.: 10/294,178

(22) Filed: Nov. 14, 2002

Related U.S. Application Data
(63) Continuation-in-part of application No. 10/052,084, filed on Jan. 18, 2002.

(51) Int. Cl. A23G 1/00

(52) U.S. Cl. 426/104

(57) ABSTRACT

A treat for a dog made from pig skin taken from the body of the pig. The skin is cut to a desired shape, folded or rolled and pressed between two dies to form a shaped member which may be a replica or representation of a pig's ear, rib, or a pork chop. The pressed member is heated, smoked, and sterilized.

This application is a continuation-in-part of U.S. patent application Ser. No. 10/052,084, filed Jan. 18, 2002.

### BACKGROUND OF THE INVENTION

1. Field of the Invention

The invention relates to treats to be chewed by pet animals.

2. Description of the Prior Art

Dog treats made from pig ears have been popular recently. Pig ears are removed from a pig, dried and seasoned, and sold to pet owners which give the processed ears to their dogs to chew. Problems have occurred in the use of these treats in that the ears may have salmonella and may be dirty, oily and hairy.

U.S. Pat. Nos. 3,368,528; 5,635,237; 6,033,715; 6,042,873; 6,060,100; and U.S. Pat. No. 6,277,420B1 disclose pet treats made from animal skins or parts.

### SUMMARY OF THE INVENTION

It is an object of the invention to produce a member which is a representation or replica of an animal part for use as a dog treat which is clean, safe, and which can be produced consistently.

It is a further object of the invention to provide a new and useful smoking system and process for smoking the member to obtain a smoked taste and smell.

The member is produced from the skin of a pig taken from its body. The skin is cut into a given shape, formed to a pre-shaped member and pressed and heated to produce a replica of an animal part that will retain its shape.

In the embodiment disclosed, the member may be a replica of a pigs ear, a pork chop, a pigs rib, etc.

### BRIEF DESCRIPTION OF THE DRAWINGS

FIG. 1A is an isometric view of the front side of the replica of a pig ear of the invention.

FIG. 2A is a view of the rear side of the ear of FIG. 1.

FIG. 2B is a front view of the ear of FIG. 1.

FIG. 3A is an edge view of the ear of FIG. 1 as seen from the right edge of the ear of FIG. 1.

FIG. 3B is an edge view of the ear of FIG. 1 opposite that of FIG. 3A.

FIG. 4A is an edge view of the ear of FIG. 1 as seen from the upper edge.

FIG. 4B is an edge view of the ear of FIG. 1 as seen from the lower edge.

FIG. 5 is an enlarged cross-section of FIG. 2A taken along lines 5-5 thereof.

FIG. 6 illustrates a press used in forming the ear of FIGS. 1-5.

FIG. 7 is a top plan view of the female die used in the press of FIG. 6.

FIG. 8A is an isometric view of a portion of the die of FIG. 7.

FIG. 8B is the opposite side view of the die of FIG. 8A.

FIG. 9 is an end view of the female die of FIGS. 7 and 8.

FIG. 10 is a plan view of the male die used in the press of FIG. 6.

FIG. 11 is an isometric view of the male die of FIG. 10.

FIG. 12 is a side view of the female and male dies of the press of FIG. 6.

FIGS. 13-19 illustrates the steps followed in processing the skin of an animal to form a pressable skin shape which is applied to the dies of FIGS. 7-12 to form the final shape of the ear of FIGS. 1-5.

FIG. 20 illustrates a heater for heating the pressed ears.

FIG. 21 is a side view of a conveyor system for smoking the ears after they have been heated.

FIG. 22 is a cross-sectional view of the system of FIG. 21.

FIG. 23 is a portion of a top plan view of the conveyor belt of the system of FIGS. 21 and 22.

FIG. 24 is an electric heating device of the system of FIGS. 21-23.

FIG. 25 illustrates one of the trays and containers employed in the conveyor system for holding a ingredient mixture for smoking purposes.

FIG. 26 is an end view of the exit end of the conveyor system of FIGS. 21-23.

FIG. 27 illustrates a system for sterilizing the smoked ears.

FIG. 28 is an isometric view of a replica or representation of a pork chop of another embodiment of the invention.

FIG. 29 is a plan view of one side of the member of FIG. 28.

FIG. 29A is a cross-section of FIG. 29 taken along the lines 29A-29A thereof.

FIG. 29B is a cross-section of FIG. 29 taken along the line 29B-29B thereof.

FIG. 29C is a cross-section of FIG. 29 taken along the lines 29C-29C thereof.

FIG. 29D is a cross-section of FIG. 29 taken along the lines 29D-29D thereof.

FIG. 30 is a plan view of the other side of the member of FIG. 28.

FIG. 31 is an edge view of FIG. 29 as seen along lines 31-31 thereof.

FIG. 32 is an edge view of FIG. 29 as seen along lines 32-32 thereof.

FIG. 33 is an edge view of FIG. 29 as seen along lines 33-33 thereof.

FIG. 34 is an edge view of FIG. 29 as seen along lines 34-34 thereof.

FIG. 35 is a layer of pig skin blanks in an unfolded state used to form the treat of FIGS. 28-34 with scraps of smaller pieces of pig skin to be placed between the folded halves when folded as shown in FIG. 36.

FIGS. 37 and 38 are male and female dies used to press the pre-shaped treat of FIG. 36 to the desired shape.

FIG. 39 is a plan view of one side of the treat of FIGS. 28-34 illustrating the folded layers thereon.

FIG. 40 is an isometric view of a replica or representation of a pork rib of another embodiment of the invention.

FIG. 41 is a plan view of one side of the member of FIG. 40.

FIG. 42 is a plan view of the side of the member of FIG. 40 opposite that of FIG. 41.

FIG. 43 is a plan view of the upper side of the dog treat of FIG. 41.

FIG. 44 is a view of the lower side of the dog treat of FIG. 41.

FIG. 45 is a view of the right side of the dog treat of FIG. 41.

FIG. 46 is a view of the left side of the dog treat of FIG. 41.

FIG. 47 is a layer of a pig skin blank in an unfolded or unrolled state used to form the treat of FIGS. 40-46 with scraps of smaller pieces of pig skin to be placed within the skin blank when rolled to form the pre-shaped blank of FIG. 49.

FIG. 48 illustrates the rolling process.

FIG. 50 illustrate male and female dies used to press the pre-shaped treat of FIG. 49 to the desired shape.

### DESCRIPTION OF THE PREFERRED EMBODIMENTS

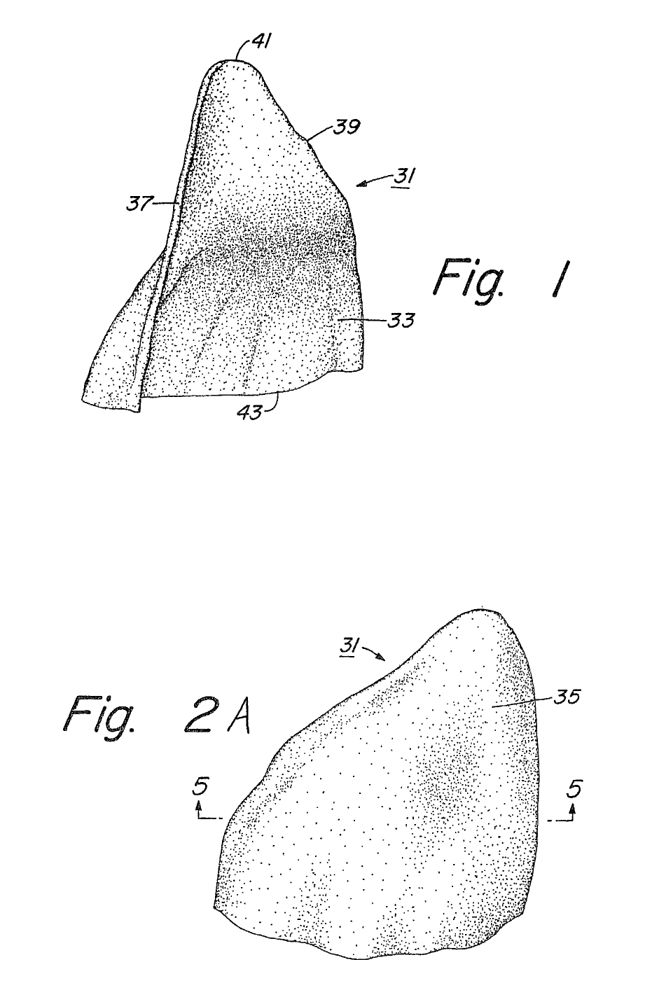

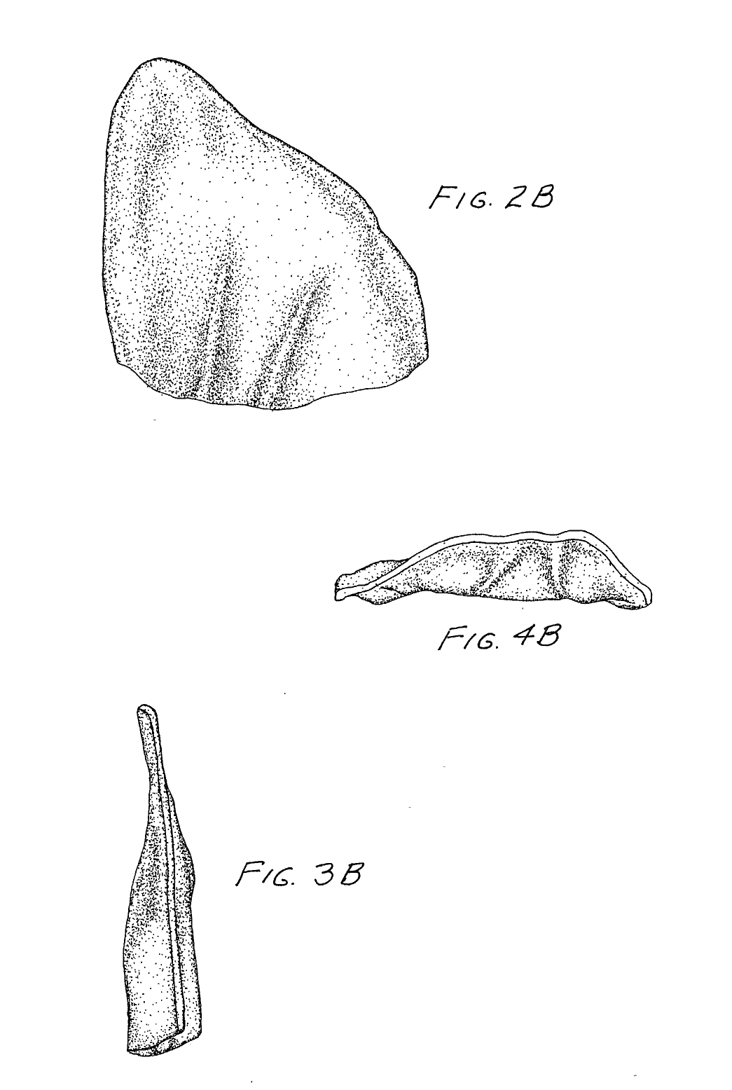

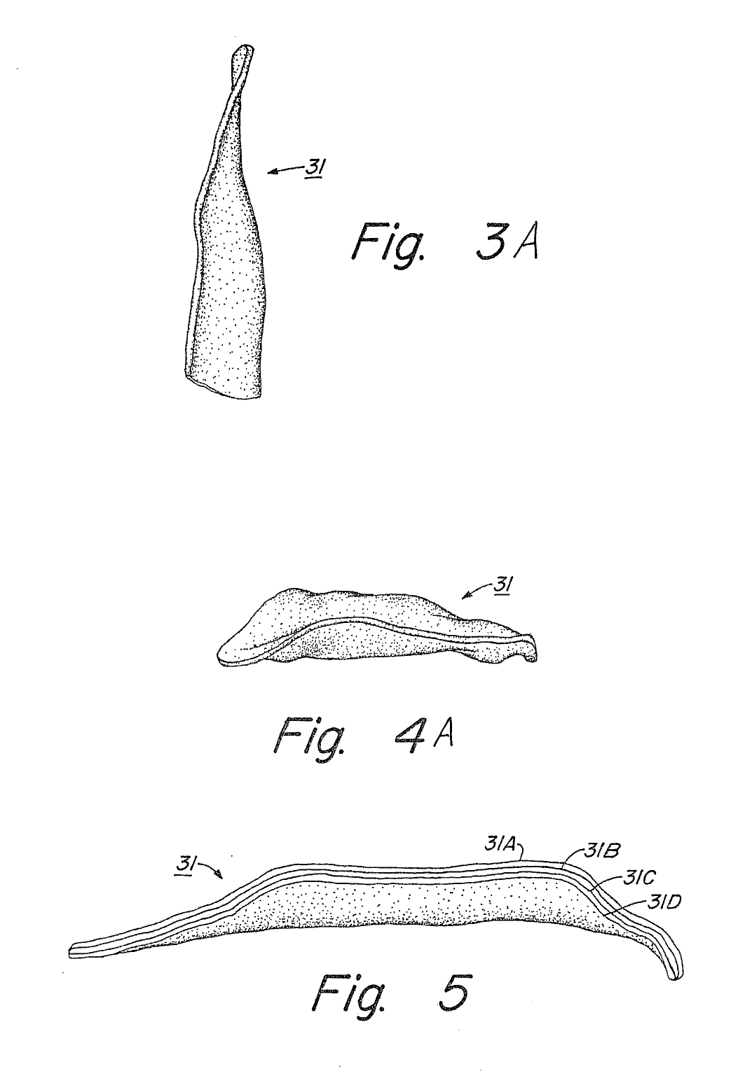

Referring now to FIGS. 1-5 the replica of a pig's ear is identified at 31. The front and back sides of the ear are shown at 33 and 35. The two side edges are identified at 37 and 39, the top edge at 41 and the bottom edge at 43. The ear 31 comprises four layers 31A, 31B, 31C and 31D.

In forming the ear, and referring to FIGS. 13-19, the skin 51 from the body of a pig (which excludes the head and limbs) is provided. Pig skin is employed since it is edible and digestible. The hair is removed from the outside of the skin and any fat on the inside is removed leaving a skin having a thickness of about 1 mil. A rectangular blank 61 is cut from the skin 51. The blank 61 is folded at 63 as shown in FIG. 13 to form the folded skin of FIG. 14. The folded skin of FIG. 14 is folded at 65 to form the folded skin of FIG. 15. The folded skin of FIG. 15 is folded at 67 to form the folded skin of FIG. 16. The folded skin of FIG. 16 is cut along solid line 69 and folded along lines 69 and 71 under the flap 73 to form the folded skin at FIG. 17. The folded skin of FIG. 17 is folded along line 75, 77 and located under the flap 73 to form the folded skin of FIG. 18. The folded skin portion 78 is folded under the flap 79 to form the folded skin blank 81 of FIG. 19 which basically has four layers.

Two of the folded ear blanks 81 then are placed in two cavities 91 and 93 of a female die 95 of a press 97. Referring to FIGS. 6, 7, and 12, the cavities 91 and 93 define two front sides of two ears 31 with their lower edges 43 abutting each other. A male die 99 is provided having two dies members 101 and 103 which define the rear sides of the two ears with their lower edges abutting each other.

Referring to FIGS. 7 and 8, the female die 95 has two elongated walls 111 and 113 which are movably supported on a base 114 which can move on the base 114 toward and away from opposite edges of the cavities 91 and 93 and two shorter walls 121 and 123 which are moveably supported on the base 114 and which can move on the base 114 toward and away from the pointed edges of the cavities 91 and 93 respectively. The inside edges of the walls 111, 113, 121, 123 define the outside shape of two pig ears.

Wall 111 has two pairs of upper and lower slots 111S1 formed therethrough at end 111A and two pairs of upper and lower slots 111S3 formed therethrough at end 111B. Wall 113 has two pairs of upper and lower slots 113S1 formed therethrough end 113A and two pairs of upper and lower slots 113S3 formed therethrough at end 113B. A pair of rods 115 with threaded ends 115A and 115B moveably extend through slots pairs 111S1 and 113S1 and a pair of rods 117 with threaded ends 117A and 117B movably extend through slot pairs 111S3 and 113S3 respectively. The rods 115 extend through and are fixedly secured to the wall 121 and the rods 117 extend through and are fixedly secured to the wall 123.

Nuts 115C are screwed to each of the rod ends 115A and secure one end of a spring 119 to each rod end 115A. The other ends of the springs 119 are attached to the wall end 111A at studs 131. Nuts 115D are secured to rod ends 115B and secure one end of a spring 121 to each rod end 115B. The other ends of the springs 121 are attached to the wall end 113A at studs 133. Nuts 117C are secured to each of the rod ends 117A and secure one end of a spring 123 to each rod end 117A. The other ends of the springs 123 are attached to the wall end 111B at studs 135. Nuts 117D are secured to each of the rod ends 117B and secure one end of a spring 125 to each rod end 117B. The other ends of the springs 125 are attached to the wall end 113B at studs 137.

Springs 141 and 143 are connected to lower studs 131 and 135 respectively and to the base 114 at 145 and 147 to normally urge the wall 111 away from the female cavities 91 and 93. Springs 151 and 153 are connected to lower studs 133 and 137 respectively and to the base 114 at 155 and 157 respectively to normally urge the wall 113 away from the female cavities 91 and 93. Springs 119 and 121 normally urge the end wall 121 away from the pointed end of the female cavity 91. Springs 123 and 125 normally urge the end wall 123 away from the pointed end of the female cavity 93. It is to be noted that the rods 115 and 117 can slide toward and away from the pointed ends of the female cavities 91 and 93 in their slots 111S1, 113S1 and 111S3, 113S3 to move their walls 121 and 123 toward and away from the pointed ends of the female cavities 91 and 93.

The outside upper ends of the walls 111 and 113 are beveled at 111SB and 113SD.

Referring to FIGS. 10 and 11, the male die member 99 has four guide blocks 161, 163, 165, 167 attached to its base 99B spaced from the two male dies 101 and 103. The blocks 165 and 167 have beveled inner edges 165B and 167B.

The female die member 95 is mounted on the stationary base 171 of the press 97 with the dies 91 and 93 facing upward and the male die member 99 is mounted on the downward facing surface of a movably member 173 of the press. The male die members 101 and 103 face downward. The member 173 is moved upward or downward by a piston 175 which extends through upper member 177 to a hydraulic cylinder 179. Stationary member 177 is supported by rods 181 coupled to base 171. The rods 181 also act to guide movement of the member 173. Hydraulic conduits 183 extend to the cylinder 179 from a control system 185 for controlling upward or downward movement of the piston 175 and hence the member 173. Movement of the piston 175 moves the male die member 99 toward or away from the female die member 95.

In using the press, the male die 99 is moved upward and two of the skin blanks 81 are laid in the female cavities 91 and 93 with their edges 43 next to each other at the juncture 92 of the female cavities 91 and 93. The smaller edges 85 will be located at the edge 91E of the die 91 and at the edge 93E of the die 93. The edges of the blanks 81 will actually overlap the edges of the dies 91 and 93.

The male die member 99 then will be moved downward. The inside edges of blocks 161 and 163 will engage the beveled edges 111SB and 113SB of the walls 111 and 113 and move the walls 111 and 113 inward and the beveled edges 165B and 167B of the blocks 165 and 167 will engage the outside edges of the end walls 121 and 123 and move the walls 121 and 123 inward. Die member 99 will continue to move downward until the male dies 101 and 103 engage and press the skin blanks 81 against the female cavities 91 and 93 to shape the skin blanks into the shape of the ear 31. In this process, any of the overlap of the skin blanks 81 over the edges of the female dies 91 and 93 will be moved inward and compressed to form two ears having the shape of ear 31 of FIGS. 1-5.

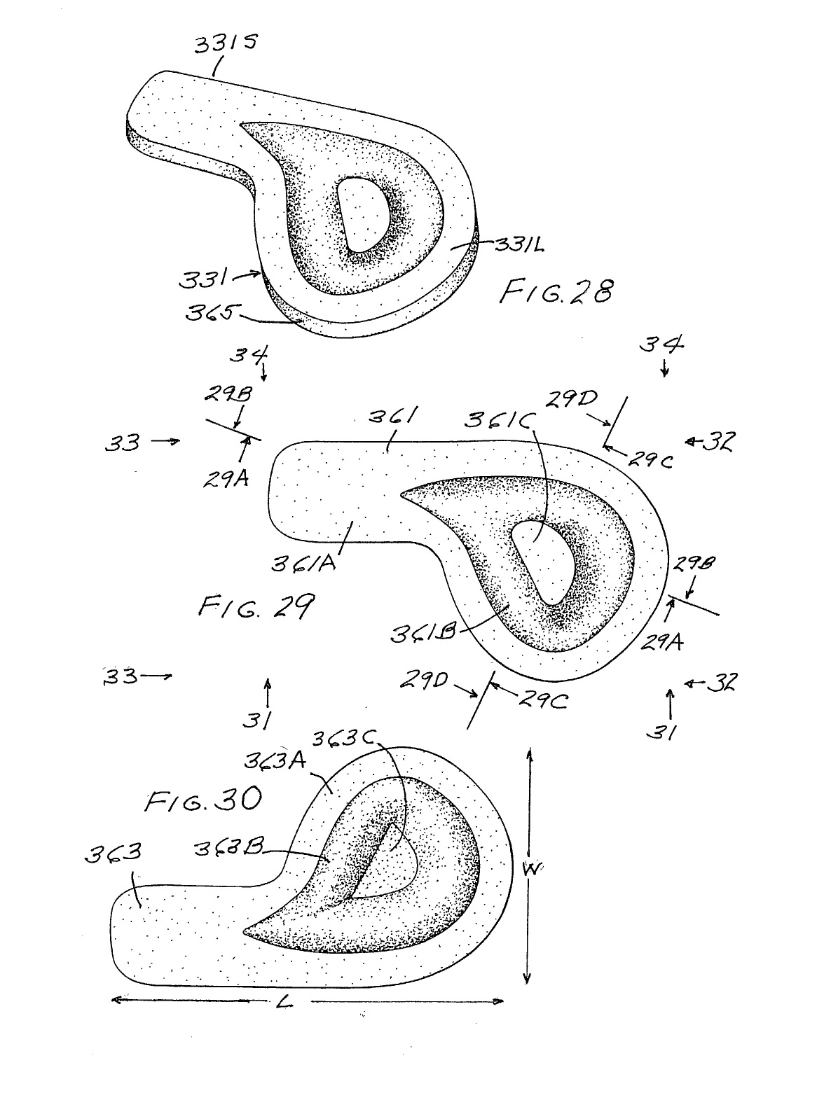

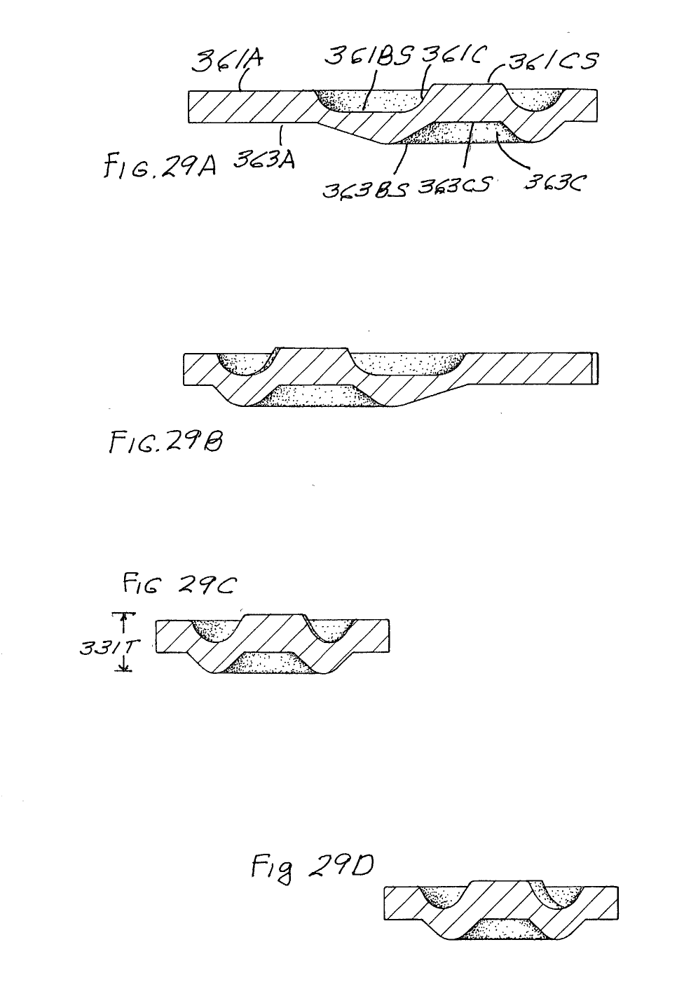

In the process, in forming the replica of the ear 31, the following steps are carried out. The skin is removed form the pig. Hair and fat is removed from the outer and inner sides of the skin. The skin is sliced to a desired shape. The skin is expanded with limestone (or lye, aqueous alkali) for two days. The alkali is taken off of the skin and the skin is counter acted with a mild acid (H₂SO₄). The skin then is dried for two days. The drying raw skin then is placed into clean water to make it soft. The skin is cut into a specific shape (rectangular as shown in FIG. 13) and folded into a shape (of FIG. 19) which will contain 4 layers of pig skin. The folding process is shown in FIGS. 13-19. The folded skin then is pressed and shaped in the hydraulic press as described previously at about 5000 psi for about 30 seconds and then removed. The pressed skin then is dried in an oven 201 (see FIG. 20) at 40-50 degrees C. for about 48 hours; 70 degrees C. for about 2 hours; 75 degrees C. for about 2 hours; and 85 degrees C. for about 2 hours. Next the dried skin is smoked in a conveyor smoking system 203, with a special mixture of ingredients such as rice stalks, wheat hulls, Chinese red sugar, and sweet potato strips to obtain a smoked taste and smell.. The ear then is pressed a second time in the hydraulic press 97 to shape again any loose edges. Antiseptic is applied to the skin and it is sterilized at 205 (see FIG. 27) by ozone for one night. The skin then is packed in a germ free packing room.

The concentration of the mixture may be sugar 20%, wheat hulls 40%, rice stalks 20%, and sweet potato strips 20%.

In one embodiment, the rectangular blank 61 of FIG. 13 may have dimensions in inches of 6×13, however, these dimensions may vary.

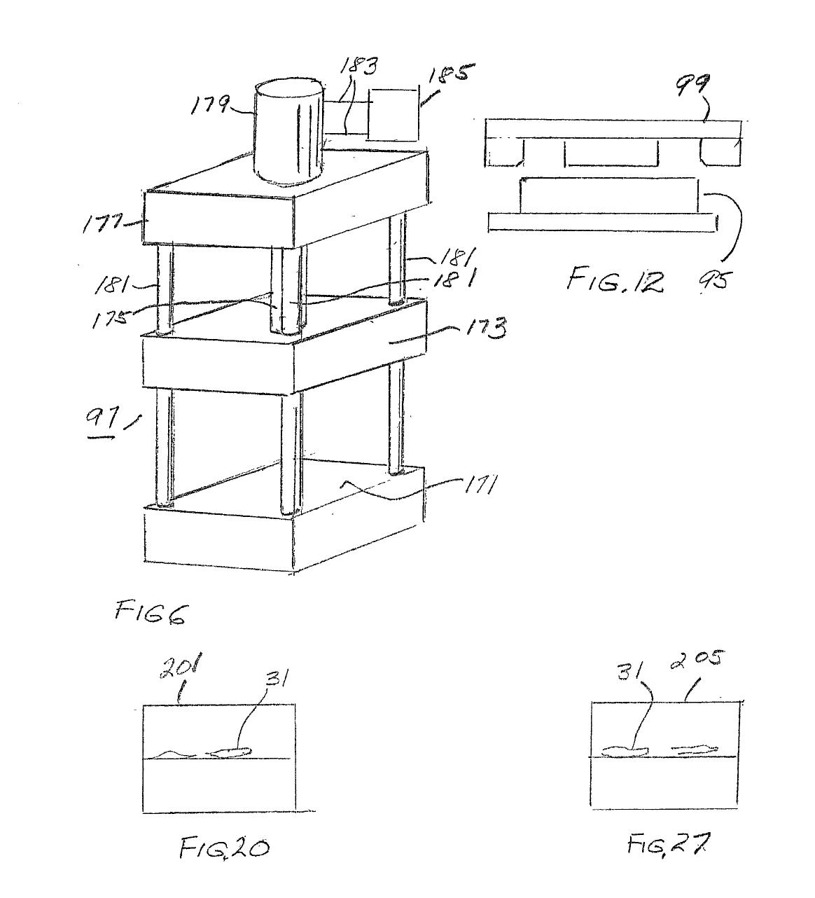

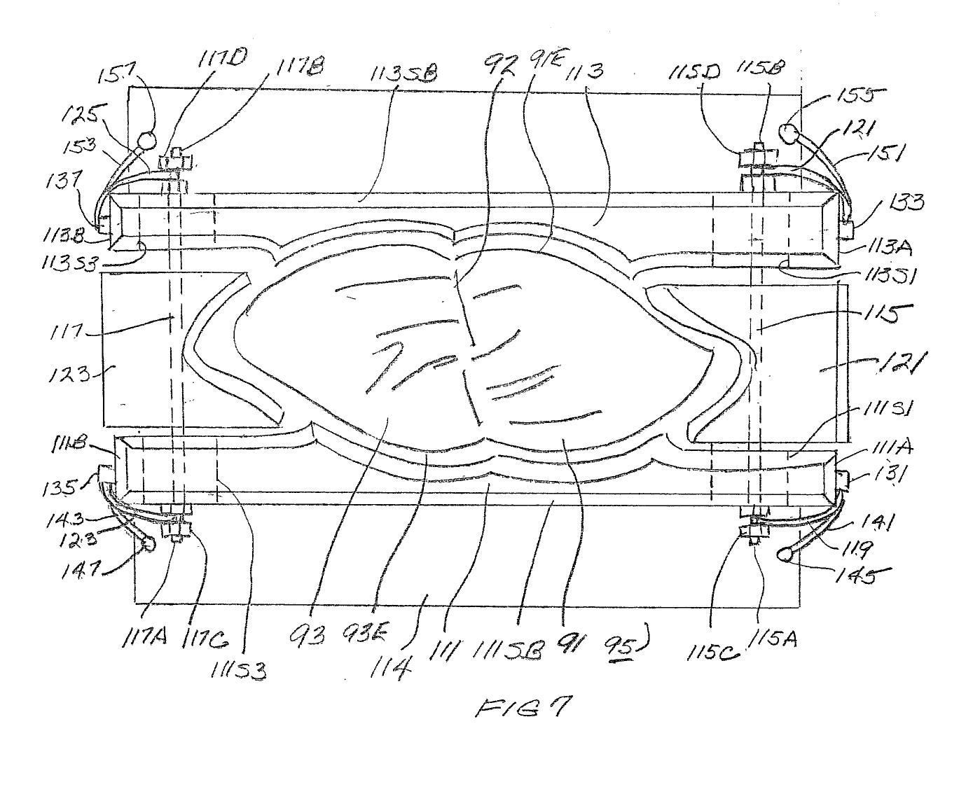

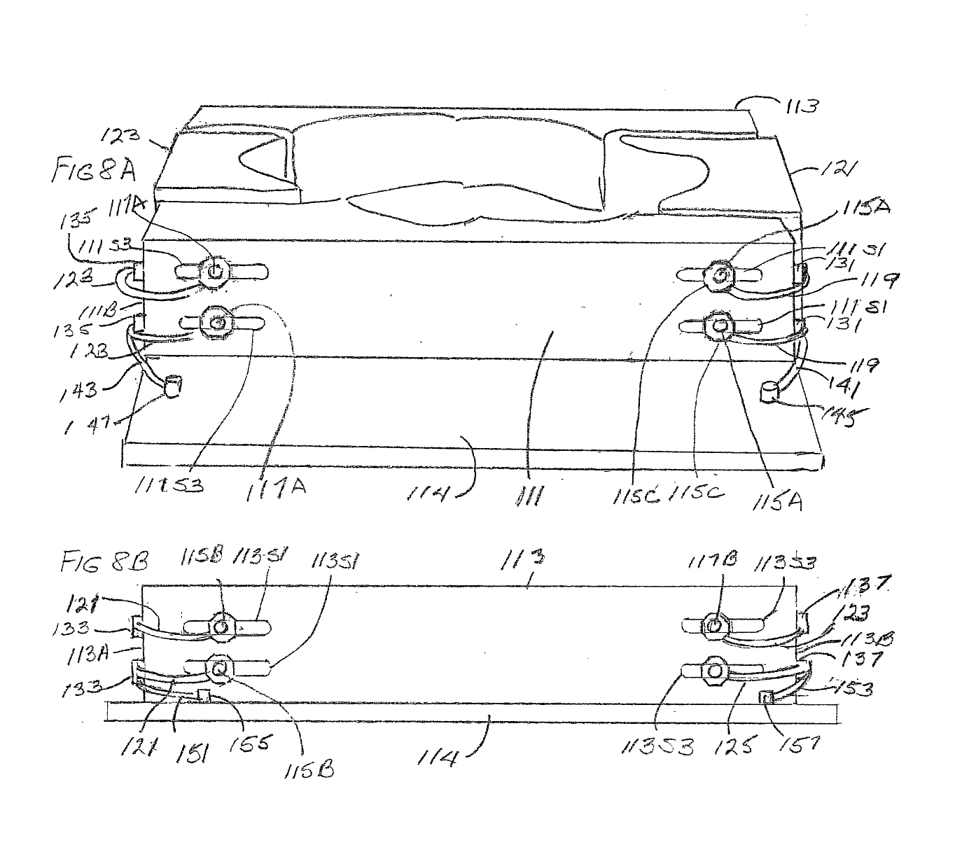

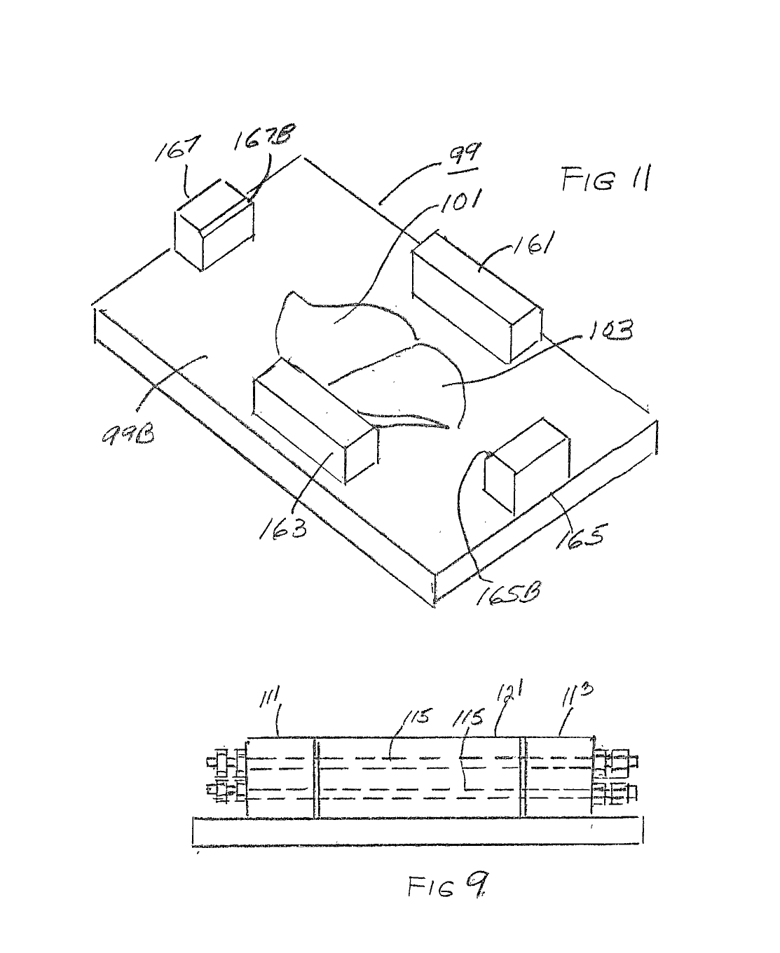

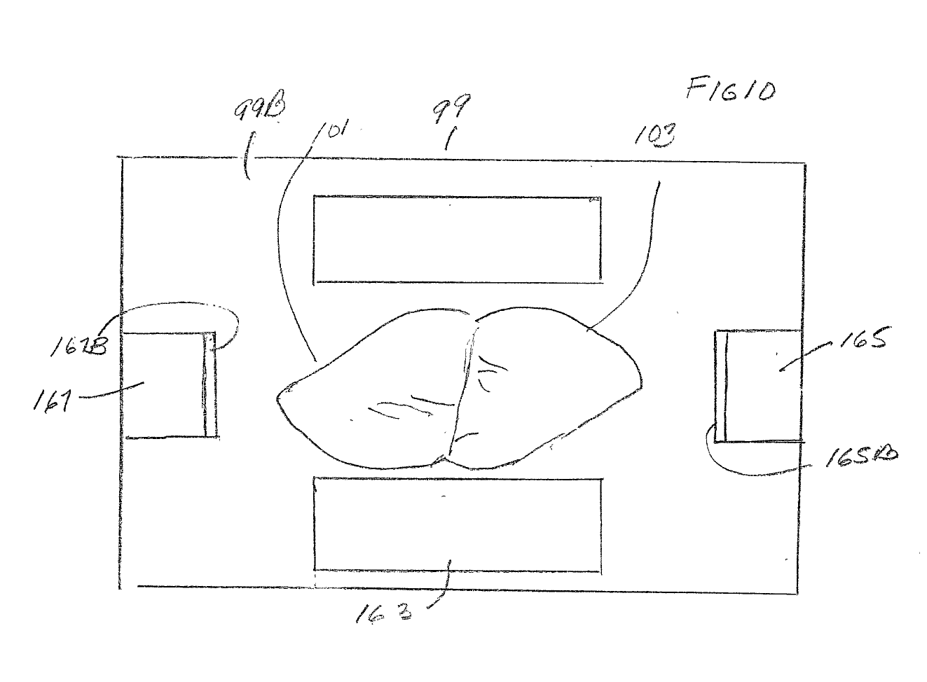

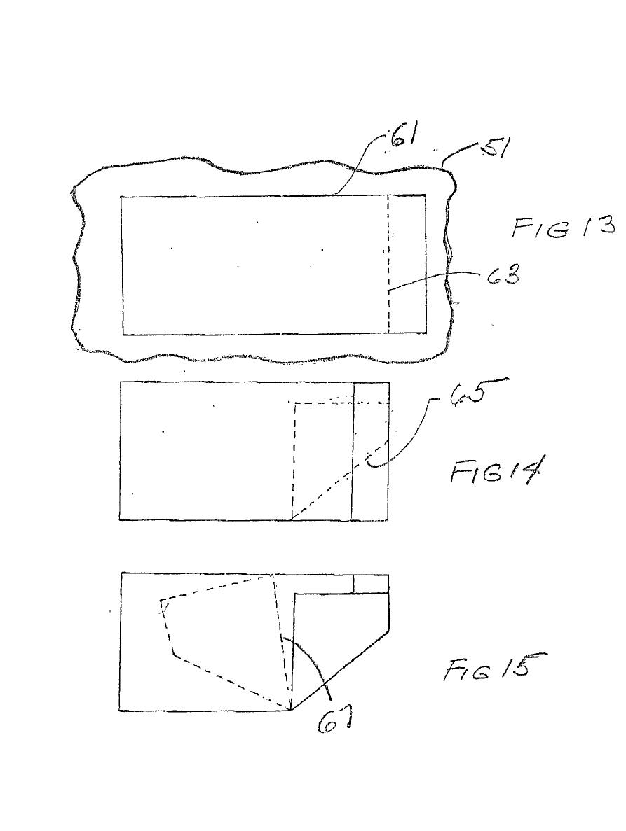

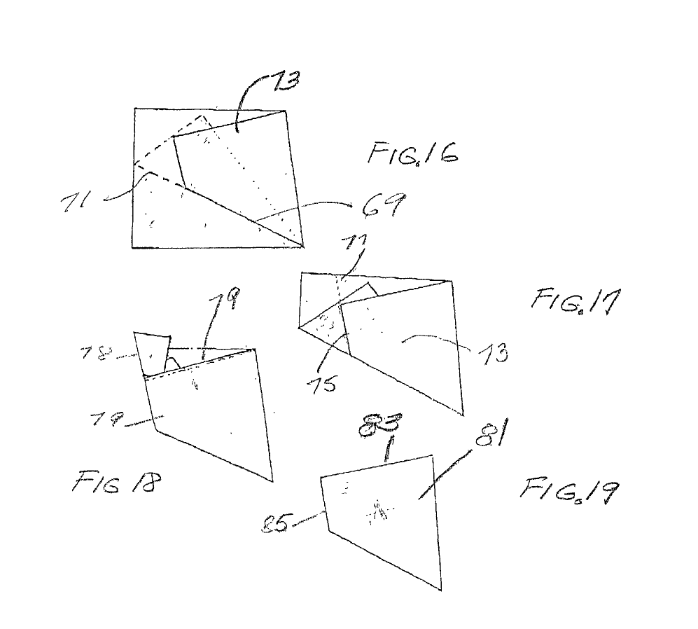

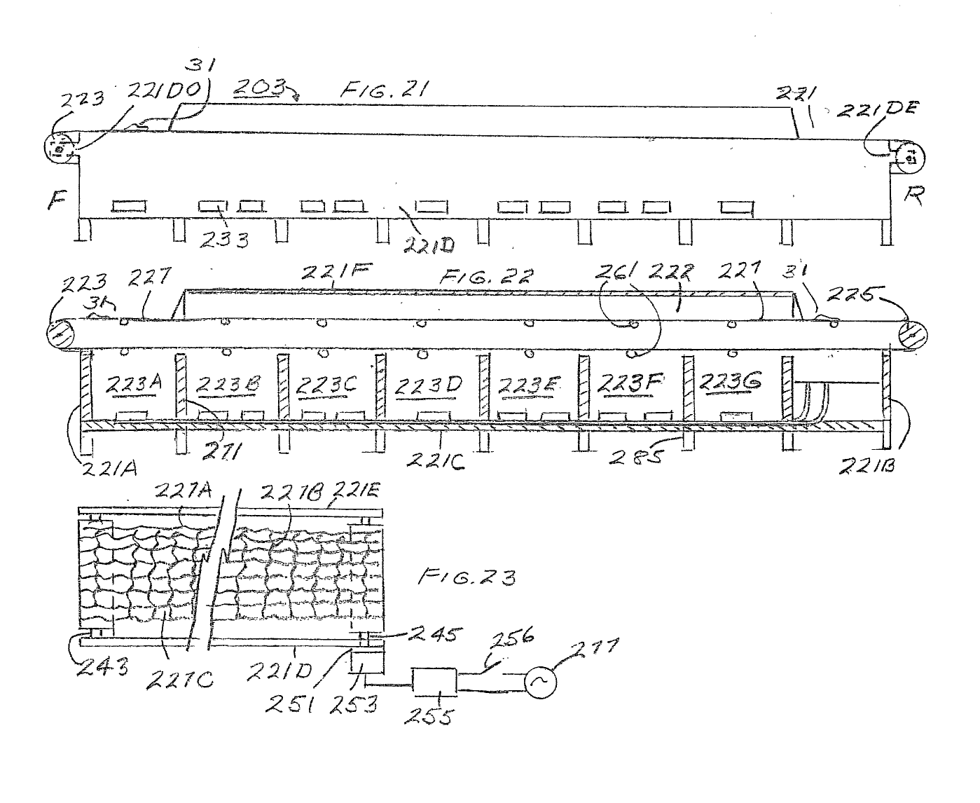

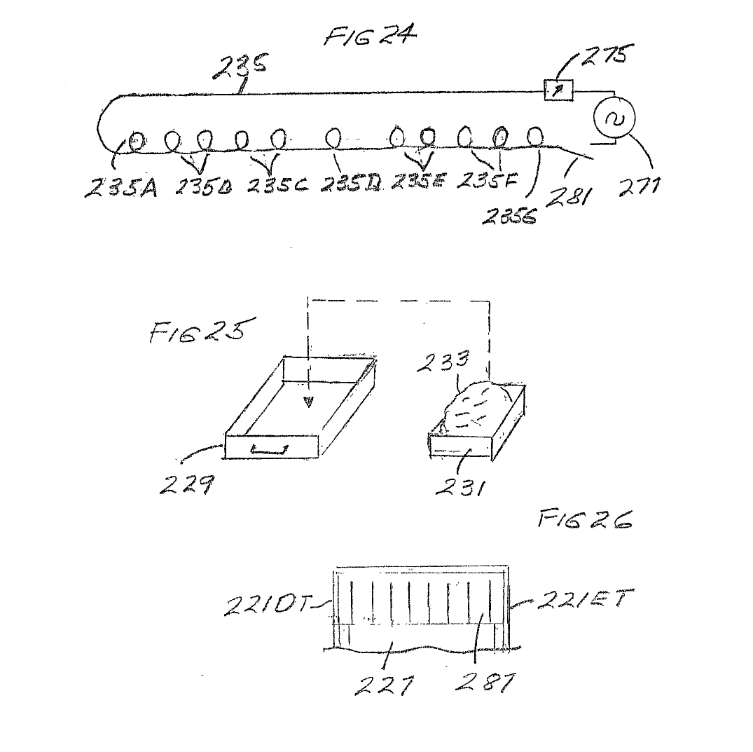

Referring to FIGS. 21-26, the conveyor smoking system 203 comprises an elongated frame 221 having two rollers 223 and 225 at front and rear ends F and R which support a continuous flexible wire belt 227 for movement above heaters 235A-235G and trays 229, 331 of ingredients 233 in the form of a mixture as disclosed above. The belt 227 has elongated flexible metal (steel) wires 227A and transverse flexible metal (steel) wires 227B forming air spaces 227C. The frame 221 comprises a forward wall 221A; a rear wall 221B; a floor 221C for supporting the trays 229 and heaters 235A-235G; two side walls 211D and 221E and a top wall 221F supported by two upper trapezoidal side wall portions 221DT and 221ET define a heating cavity 222. The wire belt 227 moves between the upper side wall portions 221DT and 221ET and under the top wall 221F in the cavity 222 around the rollers 225 and 223. Rotation is clockwise as seen in FIGS. 21-23.

The rollers 223 and 225 are fixedly connected to rods 243 and 245 which are rotatably supported by outward extending side wall portions 221DO and 221DE. A gear 251 is connected to one end of rod 245 which is rotated by an electric motor 253, the RPM of which is controlled by device 255. The RPM of the motor 251 determines the speed of travel of the belt 227 at its upper side from roller 223 to roller 225. The belt 227 is supported by a plurality of small diameter rollers 261 supported by the side walls 221D and 221E. A plurality of interior vertical walls 271 are supported by the side walls 221E and 221E and the bottom wall 221C defining a plurality of heating chambers 223A-223G. Chamber 225 is used to support the timing control 255 and a thermostat 275 used to control the current from an AC source 277 to the lead 235 of the coil heaters 235A-235G. Heaters 235A-235G are located in chambers 223A-223G respectively on the floor 221C below the trays 229. The heaters are connected to an AC source 279 by way of a switch 281. The side wall 221D has a plurality of slots 283 for allowing inserting and removal of the trays 229 with the mixture in containers 231.

The frame 221 is supported by legs 285.

The entrance and exit from the cavity 222 have flexible flaps 287 for maintaining the heat in the cavity 222 but allowing passage of the belt 227 and the pig ear replicas 231. In operation of the smoking system, the switch 281 is closed and the thermostat 275 is adjusted to obtain the desire heat in the chambers 223A-223G. After the desired chamber temperature is obtained, electrical power is applied to the motor 253 by closing switch 256 and its RPM is adjusted by unit 255. The ear replicas 31 then are loaded on the front end of the belt 227 and they are carried by the belt 227 through the cavity 222 over the chambers 223A-223C and are smoked by the rise in heat and aroma from the mixtures 233 through the openings of the belt 227. At the rear end of the conveyor 227, the smoked ears 21 are removed from the belt 227.

In one embodiment, the distance between the outer sides of rollers 223 and 225 is about 12 meters. In order to smoke the ear replicas to obtain replica colors of light, medium, or dark, the RPM of the motor 253 is adjusted such that each ear replica 31 takes 2, 4, or 7 minutes respectively to pass from the front end to the rear end of the system 221 on the wire belt 227.

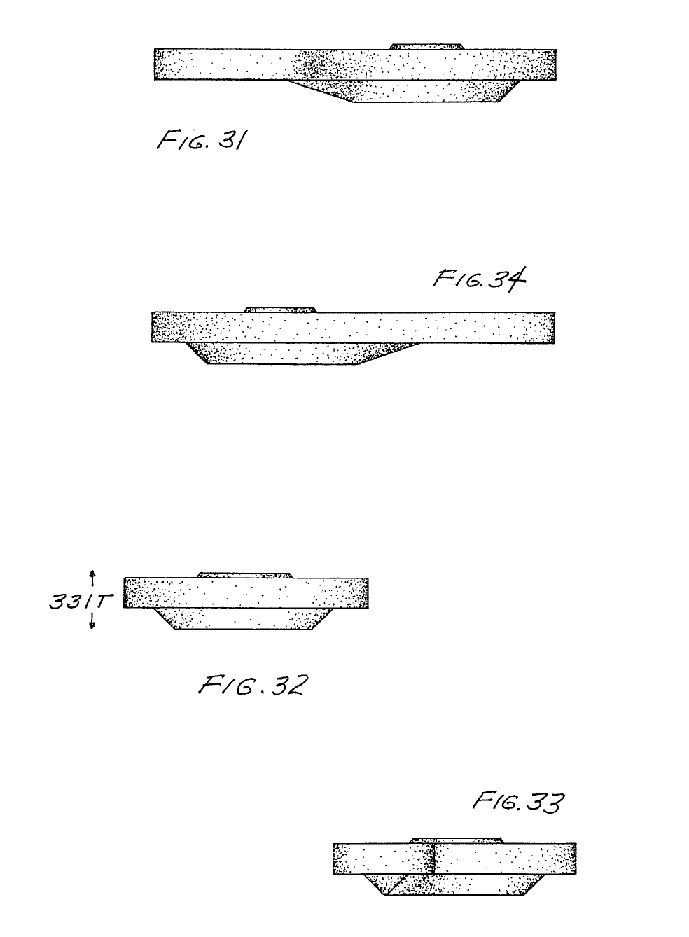

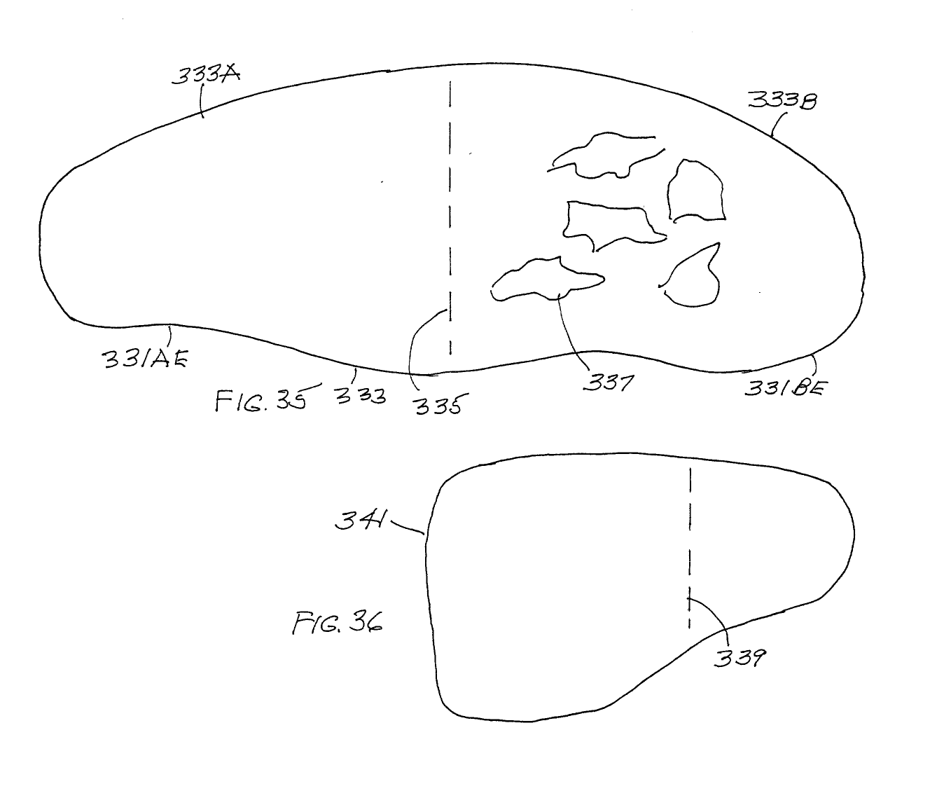

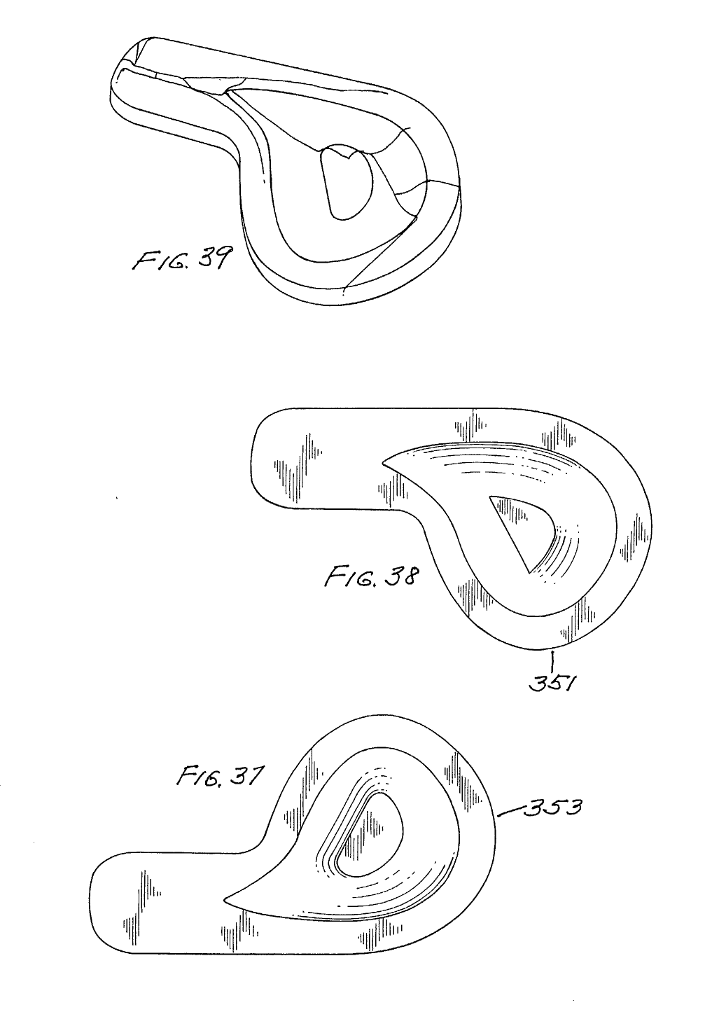

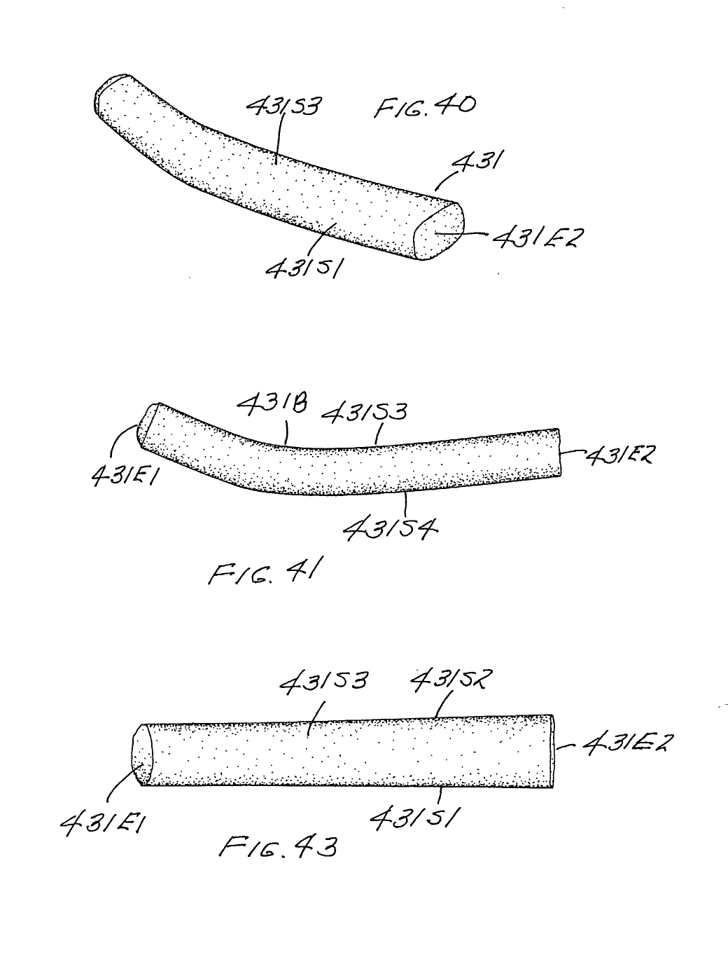

Referring now to FIGS. 28-39 there is disclosed a pork chop 331 formed of pig skin which is produced by forming a pre-shaped member which is pressed to the desired shape using suitable male and female dies employed in the press system of FIGS. 6-12; and then processed in the system of FIGS. 20-27. The pork chop 331 is formed from a blank 333 cut from the pig skin 51 which it is folded along line 335. Small pieces 337 of pig skin will be placed between the two folded halves 333A and 333B and the smaller ends 331AE and 331BE will be tied together with a pig skin strip 339 to form a pre-shaped treat 341. The pre-shaped treat then will be placed in a cavity of a female die 351 and a male die 353 will be moved downward to form the shaped member 331. The male die will be moved upward and the shaped member 331 will be removed from the dies and dried in the oven 21 of FIG. 20; smoked in the system 203 of FIGS. 21-26; pressed a second time in the press 97 and sterilized in the system 207 as described previously in the formation of the replica 31 of a pig's ear.

Referring to FIGS. 28-34, the treat 331 comprises an enlarged portion 331L and a small portion 331S with two opposite sides 361 and 363 and a surrounding edge 365. The treat 331 has a given length L, width W, and thickness the latter of which is defined by line 331T. The side 361 comprises an outer surface 361A surrounding a depressed portion 361B which surrounds an inner or elevated portion 361C. The surface 361B is generally planar as is the surface 361CS of the inner portion 361C. The depressed portion 361B has a surface 361BS with the plane of surface 361A being located between surface 361CS and the most depressed portion of surface 361BS.

The side 363 comprises an outer surface 363A surrounding an elevated portion 363B which surrounds an inner depressed portion 363C. The surface 363A is generally planar as is the surface 363BS of the elevated portion 363B. The depressed portion 363C has a surface 363CS located between surface 363BS and surface 363A.

The female die 351 will be the reverse of side 361 and the male die 353 will be the reverse of side 363 with the die 351 substituted for the dies 91, 93 and the die 353 substituted for the die 101, 103. The dies 351 and 353 will be attached to press members 95 and 99 such that the enlarged surfaces which form the enlarged portion 331L of the member 331 will be in alignment and the smaller portion which form the smaller portion 331S of the member 331 will be in alignment. The portions 111, 113, 121 and 123 of the press will have inner edges which conform to the shape of the edge of the female die 351.

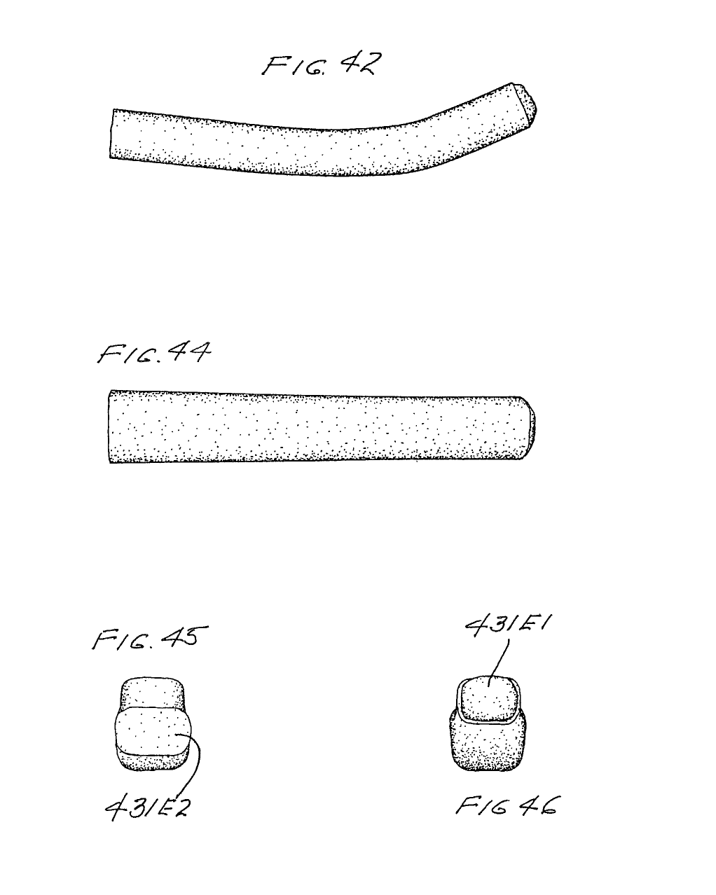

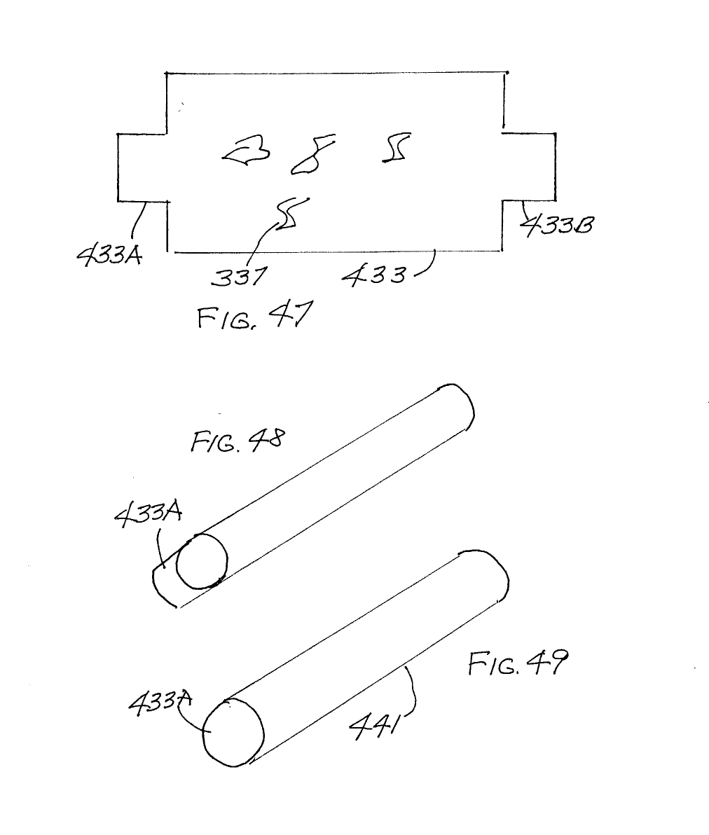

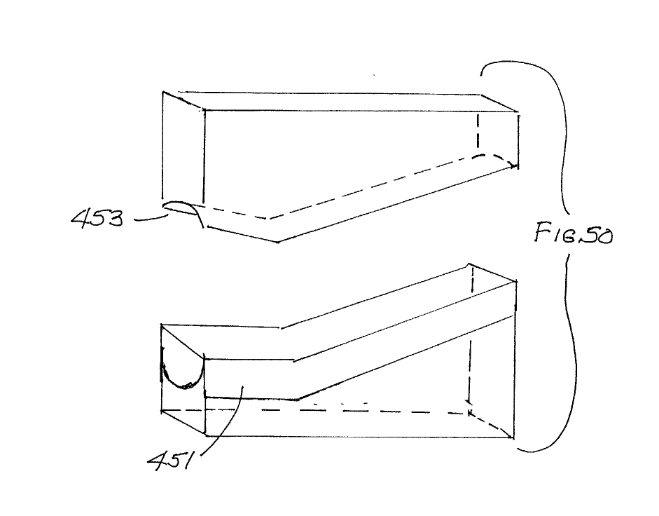

Referring now to FIGS. 40-50 there is disclosed a pork rib 431 formed of pig skin which is produced by forming a pre-shaped member which is pressed to the desired shape using suitable male and female dies employed in the press system of FIGS. 6-12; and then processed in the system of FIGS. 20-27. The pork rib 431 is formed from a blank 433, cut from the pig skin 51. The blank 433 has two tabs 433A and 433B. Small pieces 337 of pig skin will be placed on the blank 433 which then will be rolled into a cylinder and the two tabs 433A and 433B will be tucked under the rolled skin 433 to form a pre-shaped treat 441. The pre-shaped treat they will be placed in a cavity of a female die 451 and a male die 453 will be moved downward to form the shaped member 431. the male die will be moved upward and the shaped member 431 will be removed from the dies and dried in the oven 21 of FIG. 20; smoked in the system 203 of FIGS. 21-26; pressed a second time in the press 97 and sterilized in the system 207 as described previously, in the formation of representation 431 of a pig's rib.

Referring to FIGS. 40-46, the treat 441 comprises two flattened sides 431S1 and 431S2, two rounded sides 431S3 and 431S4 and two ends 431E1 and 431E2 and has a bend 431B such that the treat 431 has a curved shape.

The die 451 will be substituted for the dies 91, 93 and the die 453 will be substituted for the die 101, 103 of the press system of FIGS. 6-12. The dies 451 and 453 will be attached to the press members 95 and 99. The portions 111, 113, 121, and 123 will not be needed.

1. A replica of an animals ear to be used as a treat for a pet animal, comprising:
a plurality of layers of pig skin formed from a single layer of pig skin taken from the body of a pig and folded to obtain said plurality of layers formed in the shape of an animals ear,
said plurality of layers being formed such that each layer is located adjacent to another of said layers.

2. The replica of claim 1, wherein:
said plurality of layers are treated with smoke to obtain a smoked taste and are sterilized.

3. The replica of claim 1, wherein:
said animal ear is a pig's ear.

4. The replica of claim 2, wherein:
said animal ear is a pig's ear.

5. A method of forming a treat for a pet animal, comprising the steps of:
obtaining the skin from the body of a pig,
cutting said skin in a desire configuration to form a precut skin blank,
folding said precut skin blank to a desired shape having a plurality of layers to form a folded skin,
applying pressure and heat to said folded skin to form said folded skin in the shape of a pig's ear.

6. The method of claim 5, wherein:
pressure is applied to said folded skin by locating said folded skin between two dies,
applying pressure to said two dies to form a pressed folded skin in the shape of a pig's ear, and
releasing said pressed folded skin from said two dies.

7. The method of claim 6, wherein:
said pressed folded skin is heated, smoked, and sterilized.

8. The method of claim 7, wherein said pressed folded skin is smoked by:
placing said pressed folded skin on a continuous belt with passages formed therethrough, and
moving said belt with said pressed folded skin sequentially over a plurality of heated containers with a mixture of ingredients for producing a desired heated aroma which passes through said belt to said pressed folded skin.

9. A system for smoking treats formed of animal skin, comprising:
a frame for supporting two spaced apart rollers with a continuous belt supported by said rollers for supporting and for moving animal skin treats to be smoked,
said belt having passages formed therethrough,
said frame comprising a plurality of heating and smoking chambers located below said belt and an upper cavity through which the upper side of said belt passes,
each heating and smoking chamber comprising a heating means and a container for holding a mixture of ingredients for producing an aroma which passes upward through said belt into said cavity, and
means for rotating one of said rollers for moving said belt around said rollers and through said cavity for moving animal treats supported by said belt sequentially over each of said chambers.

10. A method of forming a treat for a pet animal, comprising the steps of:
obtaining the skin from the body of a pig,
cutting said skin in a desire configuration to form a precut skin blank,
forming said precut skin blank to a desired shape to form a pre-shaped member,
applying pressure and heat to said pre-shaped member to form a shaped member.

11. The method of claim 10, wherein:
pressure is applied to said pre-shaped member by locating said pre-shaped member between two dies,
applying pressure to said two dies to form a shaped member, and
releasing said shaped member form said two dies.

12. The method of claim 11, wherein:
said shaped member is heated, smoked, and sterilized.

13. The method of claim 12, wherein said shaped member is smoked by:
placing said shaped member on a continuous belt with passages formed therethrough, and
moving said belt with said shaped member sequentially over a plurality of heated containers with a mixture of ingredients for producing a desired heated aroma which passes through said belt to said shaped member.

14. An animal treat, comprising:
a layer of pig skin formed in the shape of a pork chop and having first and second opposite facing sides and a surrounding edge defining an enlarged portion with a smaller potion extending from said enlarged portion,
said treat having given dimensions of length, width, and thickness with said thickness extending along a line perpendicular to said length and width,
said first side comprising a first outer surface portion which surrounds a first depressed surface portion with said first depressed surface portion surrounding a first inner surface portion,
said first outer surface portion being located spaced from and between first and second planes perpendicular to said line and which first and second planes extend through surfaces of said first inner surface portion and said first depressed surface portion respectively,
said second side comprising a second outer surface portion which surrounds an elevated surface portion with said elevated surface portion surrounding a second depressed surface portion,
said second outer surface portion being located spaced from and on one side of third and fourth planes which extend through surfaces of said elevated surface portion and said second depressed surface portion respectively.

15. The animal treat of claim 14, wherein:
said layer of pig skin encloses smaller portions of pig skin.

16. An animal treat, comprising:
a layer of pig skin formed in the shape of a pig's rib comprising a curved member having two generally flat sides, an outer curved side, an inner curved side and two ends.

17. The animal treat of claim 16, which:
The animal treat of claim 16, wherein:
said layer of pig skin encloses small portions of pig skin.
